(19) United States
(12) Patent Application Publication
(10) Pub. No.: US 2015/0121356 A1
(43) Pub. Date: Apr. 30, 2015

(54) ELECTRONIC DEVICE AND METHOD FOR UPGRADING OPERATING SYSTEM

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: MIN YANG, Wuhan (CN); XIN-SHU WANG, Wuhan (CN); JIAN-HUNG HUNG, New Taipei (TW)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/140,528

(22) Filed: Dec. 25, 2013

(30) Foreign Application Priority Data
Oct. 24, 2013 (CN) 2013105064912

(51) Int. Cl. G06F 9/445; G06F 1/32

(52) U.S. Cl. CPC G06F 8/65; G06F 1/3234
USPC 717/168

(57) ABSTRACT

In a method of upgrading an operating system of an electronic device, the electronic device sends an informing message to inform a basic input-output system (BIOS) of the electronic device, when the operating system is determined to be upgraded by the electronic device. Once the electronic device is wakened from a sleep mode by the BIOS, the electronic device upgrades the operating system, and controls the electronic device to enter the sleep mode when the operating system is upgraded.

### BACKGROUND

1. Technical Field

Embodiments of the present disclosure relates to an electronic device and a method for upgrading an operating system of the electronic device.

2. Description of related art

Generally, an operating system of an electronic device (e.g., a computer) needs to be upgraded from time to time. However, the upgrading operation may affect normal use of the electronic device by the user. For example, the user may need to end an application software when the upgrading operation is performed, which is inconvenient. Therefore, an improved method for upgrading the operating system is desired.

### BRIEF DESCRIPTION OF THE DRAWINGS

FIG. 1 is a block diagram of one embodiment of an electronic device including an upgrading system.

FIG. 2 is a flowchart of one embodiment of a method for upgrading an operating system using the electronic device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word module, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

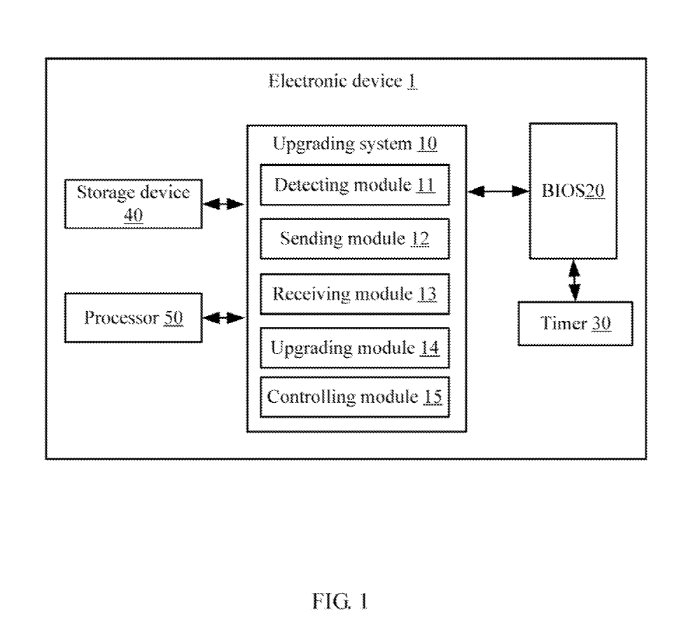

FIG. 1 is a block diagram of one embodiment of an electronic device 1 including an upgrading system 10. In this embodiment, the electronic device 1 further includes a basic input-output system (BIOS) 20, a timer 30, a storage device 40, and at least one processor 50. FIG. 1 illustrates only one example of the electronic device 1, other examples may include more or fewer components than illustrated, or have a different configuration of the various components.

The upgrading system 10 is used to upgrade an operating system of the electronic device 1. In this embodiment, the upgrading system 10 detects whether the operating system needs to be upgraded. Once the operating system is determined to be upgraded, the upgrading system 10 sends an informing message to inform the BIOS 20

The BIOS 20 sets an upgrading flag of the electronic device 1 when the informing message is received. If the electronic device 1 enters a sleep mode, the BIOS 20 activates the timer 30 to calculate a time period of the electronic device 1 entering the sleep mode when the upgrading flag is set.

The BIOS 20 further wakens the electronic device 1 from the sleep mode when the time period is greater than a predetermined value, and sends a wakening message to the upgrading system 10 that the electronic device 1 is wakened from the sleep mode. Then the upgrading system 10 upgrades the operating system when the wakening message is received.

In this embodiment, the upgrading system 10 may include a detecting module 11, a sending module 12, a receiving module 13, an upgrading module 14, and a controlling module 15. The modules 11-15 include computerized codes in the form of one or more programs that may be stored in the storage device 40. The computerized codes include instructions that are executed by the at least one processor 50.

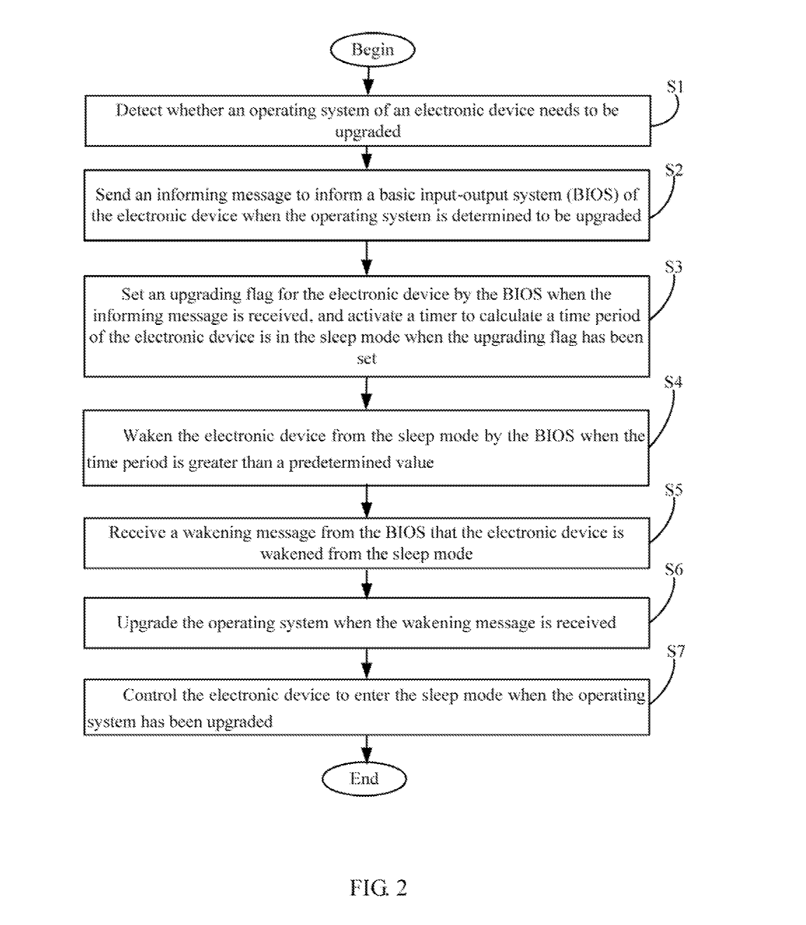

FIG. 2 is a flowchart of one embodiment of a method for upgrading an operating system using the electronic device 1. Depending on the embodiment, additional steps may be added, others deleted, and the ordering of the steps may be changed.

In step S1, the detecting module 11 detects whether the operating system of the electronic device 1 needs to be upgraded.

In one embodiment, the detecting module 11 determines that the operating system needs to be upgraded, when an automatic upgrade management program (e.g., a wuauclt.exe) is included in a list of active processes of a task manager of the electronic device 1. The automatic upgrade management program downloads patches for the operating system from Internet, and installs the patches to upgrade the operating system automatically.

In step S2, the sending module 12 sends an informing message to inform the BIOS 20 that the operating system is determined to be upgraded.

In one embodiment, the sending module 12 inactivates the automatic upgrade management program (e.g., the wuauclt.exe) before sending the informing message to the BIOS 20, to prevent the automatic upgrade management program from upgrading the operating system.

In step S3, the BIOS 20 sets an upgrading flag for the electronic device 1 when the informing message is received. If the electronic device 1 is in a sleep mode, the BIOS 20 activates the timer 30 to calculate a time period of the electronic device 1 is in the sleep mode after the upgrading flag has been set.

For example, if a user needs to leave away for one hour, the user may control the electronic device 1 to enter the sleep mode manually. Then, the BIOS 20 activates the timer 30 to calculate the time period when the upgrading flag has been set.

In step S4, the BIOS 20 wakens the electronic device 1 from the sleep mode when the time period is greater than a predetermined value (e.g., 5 minutes). The BIOS 20 further sends a wakening message to the upgrading system 10 that the electronic device 1 is wakened from the sleep mode.

In one embodiment, the BIOS 20 further inactivates a display and a fan of the electronic device 1, to save power for the electronic device 1, when the electronic device 1 is wakened from the sleep mode. In this embodiment, the BIOS 20 inactivates the display by setting a brightness value of the display equal to zero, and inactivates the fan by setting a value of Pulse Width Modulation (PWM) of the fan equal to zero.

In step S5, the receiving module 13 receives the wakening message from the BIOS 20.

In step S6, the upgrading module 14 upgrades the operating system when the wakening message is received. As mentioned above, the automatic upgrade management program upgrades the operating system automatically. In one embodiment, the upgrading module 14 upgrades the operating system by activating the automatic upgrade management program (e.g., the wuauclt.exe), to perform upgrading operation for the operating system.

In step S7, the controlling module 15 controls the electronic device 1 to enter the sleep mode after the operating system is upgraded.

Although embodiments of the present disclosure have been specifically described, the present disclosure is not to be construed as being limited thereto. Various changes or modifications may be made to the present disclosure without departing from the scope and spirit of the present disclosure.

What is claimed is:

1. A method for upgrading an operating system using an electronic device, the electronic device comprising a basic input-output system (BIOS), the method comprising:
detecting whether the operating system needs to be upgraded;
sending an informing message to inform the BIOS when the operating system is determined to be upgraded;
receiving a wakening message from the BIOS that the electronic device is wakened from a sleep mode by the BIOS;
upgrading the operating system when the wakening message is received; and
controlling the electronic device to enter the sleep mode when the operating system has been upgraded.

2. The method of claim 1, wherein the operating system is determined to be upgraded when an automatic upgrade management program is included in a list of active processes of a task manager of the electronic device.

3. The method of claim 2, wherein the automatic upgrade management program is inactivated before the informing message is sent to the BIOS.

4. The method of claim 1, wherein the BIOS wakens the electronic device by steps of:
setting an upgrading flag for the electronic device when the informing message is received;
activating a timer to calculate a time period of the electronic device is in the sleep mode after the upgrading flag has been set; and
wakening the electronic device from the sleep mode when the time period is greater than a predetermined value.

5. The method of claim 4, wherein the BIOS further inactivates a display and a fan of the electronic device when the electronic device is wakened.

6. The method of claim 5, wherein the BIOS inactivates the display by setting a brightness value of the display equal to zero, and inactivates the fan by setting a value of Pulse Width Modulation of the fan equal to zero.

7. An electronic device, comprising:
a basic input-output system (BIOS);
at least one processor; and
a storage device storing a computer-readable program including instructions, which when executed by the processor, causes the processor to:
detect whether the operating system needs to be upgraded;
send an informing message to inform the BIOS when the operating system is determined to be upgraded;
receive a wakening message from the BIOS that the electronic device is wakened from a sleep mode by the BIOS;
upgrade the operating system when the wakening message is received; and
control the electronic device to enter the sleep mode when the operating system has been upgraded.

8. The electronic device of claim 7, wherein the processor determines the operating system needs to be upgraded, when an automatic upgrade management program is included in a list of active processes of a task manager of the electronic device.

9. The electronic device of claim 8, wherein the processor further inactivates the automatic upgrade management program before sending the informing message to the BIOS.

10. The electronic device of claim 7, wherein the BIOS wakens the electronic device by steps of:
setting an upgrading flag for the electronic device when the informing message is received;
activating a timer to calculate a time period of the electronic device is in the sleep mode after the upgrading flag has been set; and
wakening the electronic device from the sleep mode when the time period is greater than a predetermined value.

11. The electronic device of claim 10, wherein the BIOS further inactivates a display and a fan of the electronic device when the electronic device is wakened.

12. The electronic device of claim 11, wherein the BIOS inactivates the display by setting a brightness value of the display equal to zero, and inactivates the fan by setting a value of Pulse Width Modulation of the fan equal to zero.

13. A non-transitory storage medium having stored thereon instructions that, when executed by a processor of an electronic device, causes the processor to perform a method for upgrading an operating system of the electronic device, the electronic device comprising a basic input-output system (BIOS), the method comprising:
detecting whether the operating system needs to be upgraded;
sending an informing message to inform the BIOS when the operating system is determined to be upgraded;
receiving a wakening message from the BIOS that the electronic device is wakened from a sleep mode by the BIOS;
upgrading the operating system when the wakening message is received; and
controlling the electronic device to enter the sleep mode when the operating system has been upgraded.

14. The non-transitory storage medium of claim 13, wherein the operating system is determined to be upgraded when an automatic upgrade management program is included in a list of active processes of a task manager of the electronic device.

15. The non-transitory storage medium of claim 14, wherein the automatic upgrade management program is inactivated before the informing message is sent to the BIOS.

16. The non-transitory storage medium of claim 13, wherein the BIOS wakens the electronic device by steps of:
setting an upgrading flag for the electronic device when the informing message is received;
activating a timer to calculate a time period of the electronic device is in the sleep mode when the upgrading flag has been set; and
wakening the electronic device from the sleep mode when the time period is greater than a predetermined value.

17. The non-transitory storage medium of claim 16, wherein the BIOS further inactivates a display and a fan of the electronic device when the electronic device is wakened.

18. The non-transitory storage medium of claim 17, wherein the BIOS inactivates the display by setting a brightness value of the display equal to zero, and inactivates the fan by setting a value of Pulse Width Modulation of the fan equal to zero.
